(19) United States
(12) Patent Application Publication
(10) Pub. No.: US 2007/0231461 A1
(43) Pub. Date: Oct. 4, 2007

(54) Method and Apparatus for Producing Stuctures From Functional Materials

(76) Inventor: Thomas Fischer, Chemnitz (DE)

Correspondence Address: STITES & HARBISON PLLC, 1199 NORTH FAIRFAX STREET, SUITE 900, ALEXANDRIA, VA, 22314, US

(21) Appl. No.: 10/599,647

(22) PCT Filed: Nov. 18, 2005
(86) PCT No.: PCT/EP05/12390

§ 371 Date: Oct. 4, 2006

(30) Foreign Application Priority Data
Dec. 2, 2004 (DE) 10 2004 058 209.2

(51) Int. Cl. B05D 5/00; B05C 11/00

(52) U.S. Cl. 427/58; 118/72

(57) ABSTRACT

Method and apparatus for producing structures from functional materials, in particular electrical functional materials, in which in a first method step first of all a homogeneous surface tension of the substrate is produced which is higher relative to the normal state of the substrate and then the surface tension of the substrate is reduced in the first or second region to a lower value, the first region being configured in the shape of the structure to be produced. Then in a further method step the functional material is applied to the substrate, the functional material being configured so that it is deposited only in the first region and thus the desired structure is formed from functional material.

The invention relates to a method and apparatus for producing structures from functional materials, in particular electrical functional materials, in which in a first method step the substrate is pretreated in such a way that at least a first and a second region are formed with different surface tensions, the first region being configured in the shape of the structure to be produced, and in a second method step the functional material is applied to the substrate, the functional material being configured so that it is deposited only in the first region and thus the desired structure is formed from functional material.

A method of producing conductive paths from an electrically conductive organic material is known from DE-A-102 29 118. For this purpose sections are defined on a substrate surface by printing of a matrix compound, so that a substrate surface with hydrophilic and hydrophobic sections is obtained. A solution of the electrically conductive organic polymer is applied to the structured substrate surface, whereby either only the hydrophilic sections or only the hydrophobic sections are wetted by the solution of the organic polymer.

A similar method is known from U.S. Pat. No. 20020083858.

However, these known methods have the disadvantage that for the structuring a material must first of all be applied. Even if the printing method used for this provides advantages, disadvantages are also produced thereby. Thus for example the structuring material first printed must be removed again or remains on the substrate without having any function after the production process. Furthermore, the co-ordination of the materials between the substrate, the first-printed structuring material and the subsequently applied functional material may prove difficult.

The object of the invention, therefore, is to make further improvements to the method and the apparatus for producing structures from functional materials, in which no additional structuring material has to be applied.

This object is achieved according to the invention by the features of claims 1 and 11.

In the method according to the invention for producing structures from functional materials, in particular electrical functional materials, in a first method step the substrate is pretreated in such a way that at least a first and a second region are formed with different surface tensions, the first region being configured in the shape of the structure to be produced. In this case first of all a homogeneous surface tension of the substrate is produced which is higher relative to the normal state of the substrate, in order then to reduce the surface tension of the substrate in the first or second region to a lower value. In a second method step the functional material is then applied to the substrate, the functional material being configured so that it is deposited only in the first region and thus the desired structure is formed from functional material.

The apparatus for carrying out the above method basically comprises a means for producing a homogeneous surface tension of the substrate which is higher relative to the normal state of the substrate, a means for reducing the surface tension of the substrate in the first or second region to a lower value and a means for application of the functional material to the substrate.

Further embodiments of the invention are the subject matter of the subordinate claims.

According to a preferred embodiment of the invention the homogeneous surface tension is produced by a corona treatment. However, within the scope of the invention it is also conceivable in this connection to use a chemical, mechanical and/or tribological treatment.

According to an embodiment of the invention the reduction of the surface tension takes place by contact with a contact structure.

The application of the functional material in the second method step can take place for example by a rolling process, a spraying process, a dipping process or a curtain coating process.

Further advantages and embodiments of the invention are explained in greater detail below with reference to the description of an embodiment and the drawings, in which:

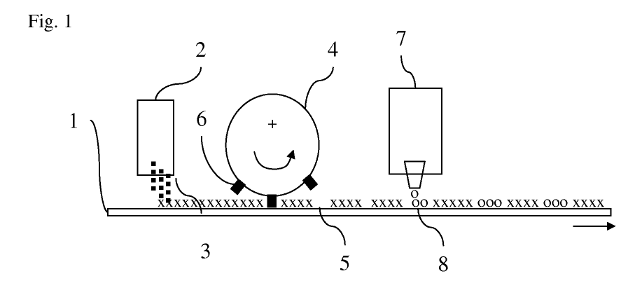

FIG. 1 shows a schematic representation of the apparatus for producing structures from functional materials, and

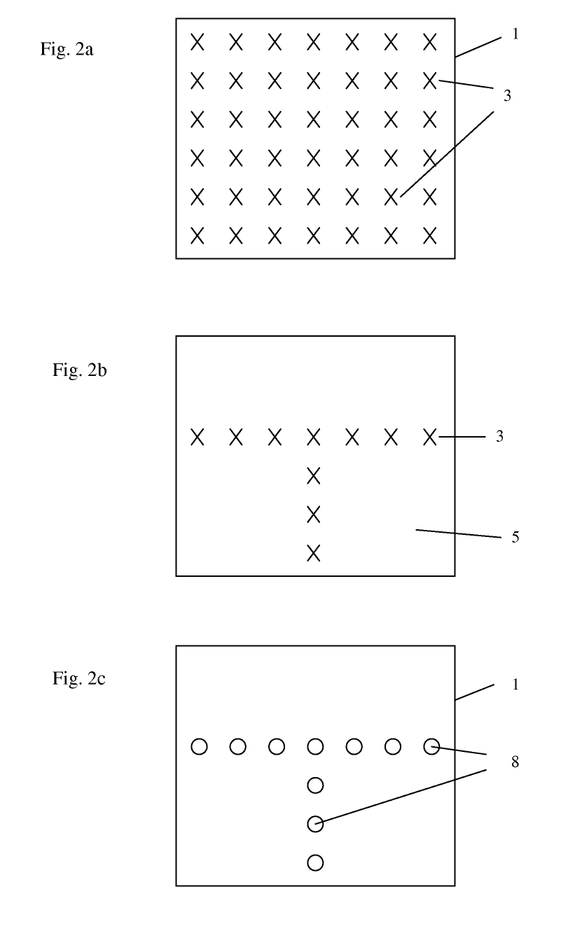

FIGS. 2a to 2c show schematic representations of the substrate surface in the different method steps.

In the method according to the invention no material is printed on or applied in other ways for the structuring of the surface polarity. On the contrary, a suitable substrate 1, for example a plastics film, in particular a PET film, is used which can adopt various surface states.

Thus the substrate 1 first of all passes through a means 2 for producing a homogeneous surface tension which is higher relative to the normal state of the substrate. Such a surface activation can be formed for example by a means for corona treatment in which the surface of the substrate 1 is irradiated with electrons and if appropriate ions in a high-voltage field. The treated surface of the substrate then has a homogeneous surface tension which is higher relative to the normal state of the substrate (see FIG. 2a).

In the next step the surface tension is reduced in specific regions with the aid of a means 4 so that at least a first region 3 and a second region 5 with different surface tensions are formed, the first region being configured in the shape of the structure to be produced.

The reduction of the surface tension, in this case in the regions 5, can be achieved for example by bringing the activated substrate in the regions 5 into contact with a contact structure of the means 4, whereby the previous activation of the surface at this location is neutralised again and the original lower surface tension again prevails.

The means 4 for reducing the surface tension can be formed for example by a roller or plate which comes into contact with the surface of the substrate and has raised contact structures 6, only the raised contact structures of the roller/plate coming into contact with the surface of the substrate. The existing contact structures are preferably made from a material which assists the deactivation. For example commercially available flexographic printing plates or dry offset plates have proved very favourable in this connection. However, other materials are also conceivable.

A corresponding structure can be produced in the activated substrate surface by a correspondingly fine configuration of the contact structure 6, whereby individual regions 5 of the substrate acquire a lower surface tension than the regions 3 which do not come into contact with the contact structures 6 and remain at the previously set high level of surface tension.

In the last method step the actual functional material 8, in particular an electrical functional material, is applied to the substrate by a means 7, the functional material being configured so that it is deposited only in the first region 3 and thus the desired structure is formed from functional material. Depending upon the type of functional material this will be deposited in the regions which are still activated or in the regions deactivated by the contact structures. In the illustrated case a functional material has been selected which is deposited in the activated regions. The desired structure formed from functional material, for example in the form of conductive tracks, is shown in FIG. 2c.

The functional material is formed for example from an electrically conductive organic polymer which is applied in the fluid state, but the viscosity must be sufficiently low and the fluid phase before a drying process must be guaranteed for a sufficiently long time so that the fluid can be distributed according to the desired structure.

All methods which enable a sufficiently uniform application of material can be considered as methods of application of the functional material 8. A spraying process in which the substrate surface is sprayed with the functional material is particularly suitable for this, whereby because of the different surface tensions the functional material is deposited only in the regions with suitable surface tension.

However, for this method step the functional material could also be applied by a dipping process as the substrate is dipped into the fluid functional material.

A curtain coating process in which the substrate surface is guided past one or several fluid jets of the functional material constitutes a further possibility.

1. Method of producing structures from functional materials, in particular electrical functional materials, in which in a first method step the substrate is pretreated in such a way that at least a first and a second region are formed with different surface tensions, the first region being configured in the shape of the structure to be produced, and in a second method step the functional material is applied to the substrate, the functional material being configured so that it is deposited only in the first region and thus the desired structure is formed from functional material, characterized in that in a first method step first of all a homogeneous surface tension of the substrate is produced which is higher relative to the normal state of the substrate and then the surface tension of the substrate is reduced to a lower value in the first or second region.

2. Method as claimed in claim 1, characterized in that the production of the homogeneous surface tension takes place by a corona treatment.

3. Method as claimed in claim 1, characterized in that the production of the homogeneous surface tension takes place by a chemical treatment.

4. Method as claimed in claim 1, characterized in that the production of the homogeneous surface tension takes place by a mechanical and/or tribological treatment.

5. Method as claimed in claim 1, characterized in that the production of the homogeneous surface tension takes place by a combination of corona chemical mechanical and/or tribological treatment.

6. Method as claimed in claim 1, characterized in that the reduction of the surface tension takes place by contact with a contact structure.

7. Method as claimed in claim 1, characterized in that in the second method step the functional material is applied in a rolling process in which a roller covered with functional material is rolled on the substrate surface, the functional material being deposited only in the region with suitable surface tension because of the different surface tensions.

8. Method as claimed in claim 1, characterized in that in the second method step the functional material is applied in a spraying process in which the substrate surface is sprayed with the functional material, the functional material being deposited only in the region with suitable surface tension because of the different surface tensions.

9. Method as claimed in claim 1, characterized in that in the second method step the functional material is applied in a dipping process, in that the substrate is dipped into the fluid functional material, the functional material being deposited only in the region with suitable surface tension because of the different surface tensions.

10. Method as claimed in claim 1, characterized in that in the second method step the functional material is applied in a curtain coating process, in that the substrate is guided past one or several fluid jets of the functional material, the functional material being deposited only in the region with suitable surface tension because of the different surface tensions.

11. Apparatus for carrying out the method as claimed in claim 1, comprising a means for producing a homogeneous surface tension of the substrate which is higher relative to the normal state of the substrate, a means for reducing the surface tension of the substrate in the first or second region to a lower value as well as a means for application of the functional material to the substrate.

12. Apparatus as claimed in claim 11, characterized in that the means for producing a homogeneous surface tension is formed by a means for corona treatment.

13. Apparatus as claimed in claim 11, characterized in that the means for reducing the surface tension is formed by a roller or plate which comes into contact with the surface of the substrate and has raised contact structures, only the raised contact structures of the roller/plate coming into contact with the surface of the substrate.
